(19) United States
(12) Patent Application Publication
(10) Pub. No.: US 2006/0266797 A1
(43) Pub. Date: Nov. 30, 2006

(54) Method for increasing the stability and/or load carrying ability of work pieces by means of friction welding

(75) Inventors: Karl U. Kainer, Hohnstorf (DE); Norbert Hott, Luneburg (DE); Hajo Dieringa, Sudergellersen (DE); Jorge D. Santos, Luneburg (DE); Axel Meyer, Hamburg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GKSS-FORSCHUNGSZENTRUM, Geesthacht (DE)

(21) Appl. No.: 10/568,321

(22) PCT Filed: Jul. 14, 2004
(86) PCT No.: PCT/DE04/01521

§ 371 Date: Feb. 16, 2006

(51) Int. Cl. A47J 36/02

(52) U.S. Cl. 228/101

(57) ABSTRACT

The invention relates to a method for at least locally increasing the stability and/or load carrying ability of work pieces (10), whereby first of all a first work piece (11) is produced by means of a conventional manufacturing method. The inventive method is characterized by the following steps: a) the first work piece (11) is then provided with a hole (13) in the area where stability and/or load carrying ability are to be increased; b) a second work piece (12) which consists of a stability-and/or load carrying ability-increasing material is introduced into the hole (13); c) in this state, the second work piece (12) is rubbed relative to the first work piece (11) according to the friction welding method until the welding temperature is reached which lies below the melting temperature of the two work pieces (11, 12), thereby obtaining a friction-welded connection between the first work piece (11) and the second work piece (12) and producing the work piece (10).

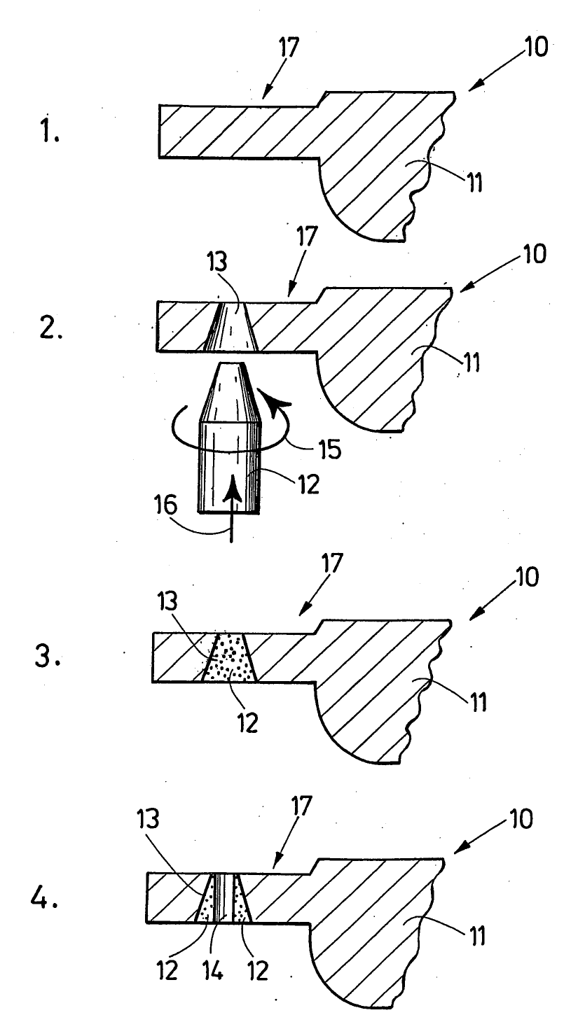

### DESCRIPTION

The invention relates to a process for increasing the stability and/or load carrying capacity of work pieces at least locally, wherein a first work piece is first produced by means of a conventional manufacturing process.

Certain work pieces which are produced from certain materials by means of known, conventional manufacturing processes, such as e.g. industrial casting processes, possess, with respect to their stability and/or load carrying capacity when used in the appropriate incorporation sites and/or with respect to the appropriate incorporation purposes, e.g. a desired low weight such as it is encountered e.g. in the case of light metal working materials, however, when choosing the working material forming the work piece, they frequently do not exhibit, specifically regarding the working material, the stability and/or load carrying capacity required or desired for the use of the work piece for the intended purpose. In order to counteract, in these cases, the low stability and/or the low load carrying capacity of such work pieces manufactured from such working materials at least at sites of the work piece subject to high stress, these areas are ‘reinforced’, as early as in the manufacturing process, by working materials in order to achieve the higher stability and/or load carrying capacity of the work pieces aimed at, at least in these local areas. In the case of a work piece produced e.g. from light metal using known metallurgic casting techniques, a cast insertion element is introduced into the mould at the corresponding site during the casting process and the casting material is cast around it in such a way that at least a local increase in stability and/or load carrying capacity is in fact achieved as intended.

In the case of metal work pieces, in particular, this regularly leads to incompatibilities regarding the electrochemical potentials of the working material of the work piece and the working material of the cast insertion element and also regarding inherent stresses. As practical results with such composite work pieces have shown, this leads not only to corrosion phenomena occurring increasingly but also to the formation of cracks as a result of the said unfavourable inherent stresses of the two working materials of the two work pieces.

If such composite work pieces are exposed to the normal environment or, indeed, to the stresses caused by salt-containing, aqueous solutions, such work pieces fail within a very short time. In this respect, greatly differing physical and mechanical characteristics of the working material forming the work piece and of the working material forming the cast insertion element also play a part in some respects. Finally, disadvantageous internal stresses caused by the actual casting process employed also arise in the course of production.

It is thus the task of the present invention to provide a process of the above-mentioned type by means of which an increase in the stability and/or load carrying capacity of work pieces is achieved at least locally, namely in the case of work pieces which, regarding their basic configuration, have been produced by means of different, generally known and, if necessary, conventional production processes, it being intended to achieve also an increased temperature stability in the case of work pieces produced by means of manufacturing processes previously used and it being intended that the process be practicable in a cost-effective manner with low expenditure on equipment.

The task is achieved according to the invention by

a. the first work piece being subsequently provided with a hole in the area where the stability and/or load carrying capacity are to be increased and subsequently

b. a second work piece consisting of a stability and/or load carrying capacity increasing working material being introduced into the hole and

c. in this state, the second work piece being rubbed relative to the first work piece according to the friction welding method until the welding temperature is reached which is below the melting temperature of the two work pieces in order to create a friction-welded connection between the two work pieces.

By means of the process according to the invention, it is advantageously achieved that composite work pieces can be produced which exhibit, at least locally, the characteristics with respect to stability, load carrying capacity and durability at high temperatures and a high resistance to wear and tear and work pieces produced in this way can thus be used in areas which had previously been totally inaccessible to such work pieces. In this respect it is possible, if the first work piece, for example, consists of a light metal working material, that all the advantageous characteristics of the light meal can be utilised for the work piece as a whole, such as the low weight and/or its low density but, in addition, the stability and/or load carrying capacity and temperature stability characteristics can also be achieved at least in the local area of the work piece which, previously, had been accessible only to work pieces of working materials with a high specific gravity and/or a high density or to working materials which are extremely difficult to process and to working materials which can be provided only at great costs.

Basically, the process according to the invention can be carried out by using all the variants of friction welding.

According to an advantageous embodiment of the process, the hole in the first work piece is a bore and the second work piece exhibits a rotation-symmetrical form, the method of friction welding being in this case that of friction stir welding, it being possible in this case for friction cone welding to be used which is a special from if friction stir welding. In this way, it is possible for reinforcements to be achieved in a controlled manner in certain local areas of the first work piece which reinforcements increase the stability and/or load carrying capacity of the work piece as a whole. In this way, the hole can have either a cylindrical or conical form, the rotation symmetrical second work piece having either a corresponding cylindrical or conical form in this case.

The hole or the bore can cross the work piece at a corresponding site of the first work piece; however, it is also possible to form the hole or the bore as a blind hole or a blind bore such that a bottom remains in the first work piece.

According to a further advantageous embodiment of the process, the hole or the bore in the first work piece is filled at least partly by the second work piece in a connected state, i.e. it is possible to form a through-hole or a blind hole or a blind bore in the second work piece to correspond to the shape of the second work piece before the latter is connected with the first work piece by the friction welding process.

Basically, the first work piece can be produced by employing any desired suitable production process. Preferably, however, the first work piece is produced in one casting manufacturing process which has the advantage that the first work piece can be highly cost-effectively mass-produced using known industrial casting processes, whereas the second work piece which exhibits the stability and load bearing capacity characteristics aimed at specifically which are then aimed at in the composite of the two work pieces for the work piece as a whole and can be made use of e.g. as commercially available semi-finished products, such that only minimal cost increases need to be recorded for the composite work piece achievable according to the invention compared with a standard work piece produced by industrial casting measures.

According to a further advantageous different embodiment of the invention, at least the first work piece consists of a light metal or a light metal alloy, the light metal alloy being preferably magnesium or a magnesium alloy or finally advantageously the light metal aluminium or an aluminium alloy.

Aluminium and magnesium, including its corresponding alloys, play an increasingly strong part in the light construction industry, i.e. in the construction of motor vehicles and in the aircraft and space industry. In the area of motor vehicle construction, in particular, there is also the requirement, apart from the low density of aluminium and magnesium, of being able to provide work pieces or structural parts of theses working materials in an extremely cost-effective manner such that work pieces are already produced in this sector in particular by known industrial casting processes. Nevertheless, there is the requirement regarding these cases that they should withstand high mechanical and electrochemical stresses at least locally. According to the invention, the good castability of magnesium or magnesium alloys or aluminium or aluminium alloys and their good mechanical processability are combined with the properties of the second working material of the second work piece which exhibit a high mechanical and electrochemical load carrying capacity but which are less easily processable and much more difficult to cast—to remain with this example—than that of the first work piece.

The invention will now be described in further detail with reference to the single drawing by way of a practical example. This shows:

in four steps the execution of the process for obtaining a composite work piece of two work pieces which are combined with each other by way of the method of friction welding.

The work piece 10 is present first of all as first work piece 11 which is illustrated in the individual manufacturing steps as a cross-section according to illustrations 1. to 4. The first work piece 11 can be any desired suitable work piece which, in the present case, exhibits a flange-type projection 17, compare illustration 1. The first work piece 11 is produced e.g. by known industrial casting processes and can consist e.g. of an aluminium or magnesium alloy or any desired other suitable working material.

A hole 13 is drilled into the flange-type projection 17 or inserted in any other suitable way. In the present case, the hole 13 has a conical form and exhibits no hole bottom. It should be pointed out that the hole or the bore 13 can also be formed in the first work piece 11 in such a way that a bottom remains in the hole or the bore 13 (not illustrated).

Subsequently, a second work piece 12 which, in the example illustrated here, is formed in a rotations symmetrical manner and also conically, is caused to rotate by means if a device not shown here, compare arrow 15, and introduced into the hole 13 in the direction of movement 16, compare arrow 16, while continually maintaining the rotation movement.

As a result of the contact between the first work piece 11 and the second work piece 12, a friction welding process takes place which is maintained until the welding temperature below the melting temperature of the two work pieces is reached.

In this way, a state according to illustration 3. of the drawing is reached in which the hole 13 is filled by the second work piece 12 forming a friction-welded connection between the first work piece 11 and the second work piece 12.

According to illustration 4., the second work piece 12 can also be provided with a through-hole 14, as illustrated in illustration 2., such that the second work piece 12 exhibits a through-hole 14 also in the end position or in the last process step according to illustration 4. In this case, the separate formation of a through-hole 14 by way of a drilling or milling process is not necessary.

However, it is also possible to drill or mill the through-hole 14 through the second work piece 12 after it has been formed according to illustration 3., i.e. after a friction-welded connection has been achieved between the first work piece 11 and the second work piece 12.

### LIST OF REFERENCES

10 work piece
11 first work piece
12 second work piece
13 hole/bore
14 through-hole
15 arrow (rotation)
16 arrow (direction of movement)
17 projection

1. Process for increasing the stability and/or load carrying capacity of work pieces at least locally, a first work piece being first produced by means of a conventional manufacturing process characterized in that
a. the first work piece is subsequently provided with a hole in an area where the stability and/or load carrying capacity are to be increased and subsequently
b. a second work piece consisting of a stability and/or load carrying capacity increasing working material is introduced into the hole and
c. in this state, the second work piece is rubbed relative to the first work piece according to a friction welding method until the welding temperature is reached which is below the melting temperature of the two work pieces in order to create a friction-welded connection between the two work pieces.

2. Process according to claim 1 wherein the hole in the first work piece is a bore and the second work piece exhibits a rotation-symmetrical form, the method of friction welding being in this case that of friction stir welding or friction cone welding.

3. Process according to claim 1 wherein the hole in the first work piece is filled at least partly by the second work piece in a connected state.

4. Process according to claim 1 wherein the first work piece is produced in a casting production process.

5. Process according to claim 1 wherein at least the first work piece consists of a light metal or a light metal alloy.

6. Process according to claim 5 wherein the light metal is magnesium or a magnesium alloy.

7. Process according to claim 5 wherein the light metal is aluminium or an aluminium alloy.

8. Process according to claim 2, wherein the bore in the first work piece is filled at least partly by the second work piece in a connected state.

9. Process according to claim 2, wherein the first work piece is produced in a casting production process.

10. Process according to claim 3, wherein the first work piece is produced in a casting production process.

11. Process according to claim 2, wherein at least the first work piece consists of a light metal or a light metal alloy.

12. Process according to claim 3, wherein at least the first work piece consists of a light metal or a light metal alloy.

13. Process according to claim 4, wherein at least the first work piece consists of a light metal or a light metal alloy.

14. Process according to claim 11, wherein the light metal is aluminium or an aluminium alloy.

15. Process according to claim 11, wherein the light metal is magnesium or a magnesium alloy.

16. Process according to claim 12, wherein the light metal is aluminium or an aluminium alloy.

17. Process according to claim 12, wherein the light metal is magnesium or a magnesium alloy.

18. Process according to claim 13 wherein the light metal is aluminium or an aluminium alloy.

19. Process according to claim 13 wherein the light metal is magnesium or a magnesium alloy.
